(19) United States
(12) Patent Application Publication
(10) Pub. No.: US 2024/0289911 A1
(43) Pub. Date: Aug. 29, 2024

(54) TILE-BASED MACHINE LEARNING GRAPHICS PROCESSING

(71) Applicant: QUALCOMM Incorporated, San Diego, CA (US)

(72) Inventors: Bijan FORUTANPOUR, San Diego, CA (US); Amir MOMENI, Arlington, MA (US)

(21) Appl. No.: 18/174,502

(22) Filed: Feb. 24, 2023

(51) Int. Cl. G06T 1/20

(52) U.S. Cl. CPC G06T 1/20

(57) ABSTRACT

A graphics processing system including: a graphics processing unit (GPU) renderer configured to render a first set of tiles based on an input frame; a machine learning (ML) graphics processor configured to perform a graphics process based upon at least a first subset of the first set of tiles to generate a second set of tiles; and a first frame generator configured to generate a first output frame based on the second set of tiles.

### FIELD

Aspects of the present disclosure relate generally to graphics processing, and in particular, to a system and method for tile-based machine learning (ML) graphics processing.

### BACKGROUND

Many computing devices, such as desktop computers, laptop computers, mobile devices (e.g., smart phones), tablet devices, augmented reality (AR) or virtual reality (VR) viewers/glasses, and others, perform enhancement graphics processing to improve image quality of a source image. For example, such enhancement graphics processing may include super-resolution, style transfer, denoising for raytracing, shadow/reflection enhancing, etc. In certain applications, the enhancement graphics processing should be performed in a specified real-time manner. However, such enhancement graphics processing is typically computationally intensive, and performing it in a real-time manner may be challenging.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to a graphics processing system. The graphics processing system includes: a graphics processing unit (GPU) renderer configured to render a first set of tiles based on an input frame; a machine learning (ML) graphics processor configured to perform a graphics process based upon at least a first subset of the first set of tiles to generate a second set of tiles; and a first frame generator configured to generate a first output frame based on the second set of tiles.

Another aspect of the disclosure relates to a method. The method includes rendering a first set of tiles based on an input frame; performing a machine learning (ML) graphics process upon at least a first subset of the first set of tiles to generate a second set of tiles; and generating a first output frame based on the second set of tiles.

Another aspect of the disclosure relates to an apparatus. The apparatus includes means for rendering a first set of tiles based on an input frame; means for performing a machine learning (ML) graphics process upon at least a first subset of the first set of tiles to generate a second set of tiles; and means for generating an output frame based on the second set of tiles.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a block diagram of an example graphics processing system in accordance with an aspect of the disclosure.

FIG. 2 illustrates a block diagram of an example tile-based graphics processing system in accordance with another aspect of the disclosure.

FIG. 3 illustrates a diagram of an example frame including a set or array of rendered tiles in accordance with another aspect of the disclosure.

FIG. 4 illustrates a diagram of an example frame including a set or array of machine learning (ML) tiles superimposed over the set or array of rendered tiles of FIG. 3 in accordance with another aspect of the disclosure.

FIG. 5 illustrates a block diagram of another example tile-based graphics processing system in accordance with another aspect of the disclosure.

FIG. 6 illustrates a flow diagram of an example method of controlling tile rendering, machine learning (ML) graphics processing, and frame displaying in accordance with another aspect of the disclosure.

FIG. 7 illustrates a flow diagram of an example method of tile rendering in accordance with another aspect of the disclosure.

FIG. 8 illustrates a flow diagram of an example method of machine learning (ML) graphics processing in accordance with another aspect of the disclosure.

FIG. 9 illustrates a flow diagram of an example method of displaying frames in accordance with another aspect of the disclosure.

FIG. 10 illustrates a flow diagram of an example method of generating an output frame in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Machine learning (ML) graphics processing, such as artificial intelligence (AI) processing or neural network processing, may be used to enhance the displaying of images (e.g., still or motion images (e.g., video)). For example, some ML graphics processing systems may perform super-resolution upon an input frame to generate an output frame with higher pixel resolution (e.g., increase the resolution by a factor of two or more). Other ML graphics processing systems may perform style transfer to modify an input frame to generate an output frame in the style of another image (e.g., render a camera image in a particular painting or cartoon style). Still other ML graphics processing system may perform denoising for raytracing to remove undesired noise from a raytraced input frame to generate an output frame. There may be other types of ML graphics processing (e.g., shadow and/or reflection enhancing, etc.).

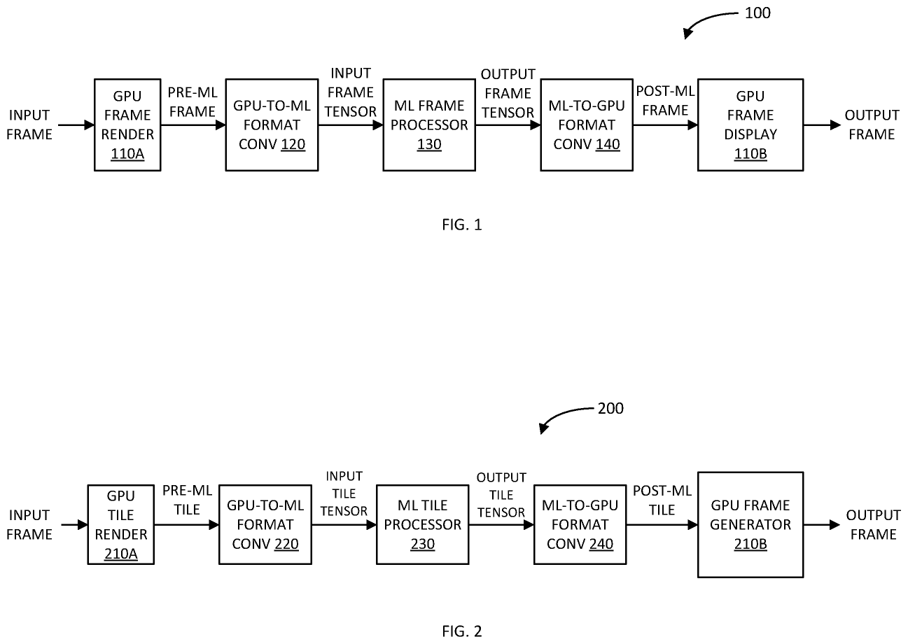

FIG. 1 illustrates a block diagram of an example graphics processing system 100 in accordance with an aspect of the disclosure. The graphics processing system 100 includes a graphics processing unit (GPU) frame renderer 110A, a GPU-to-machine learning (GPU-to-ML) frame format converter 120, a machine learning (ML) frame graphics processor 130, an ML-to-GPU frame format converter 140, and a GPU frame display component 110B.

The GPU frame renderer 110A is configured to receive information regarding an input frame from, for example, a central processing unit (CPU) running a particular application or under control of an application layer (e.g., a gaming application, or other). The GPU frame renderer 110A is further configured to render a frame (referred to herein as a “pre-ML frame”) based on the information regarding the input frame. The pre-ML frame may be in a particular GPU rendered frame format, such as in a red, green blue (RGB) pixel array format. Accordingly, the GPU-to-ML frame format converter 120 may be configured to convert the graphics format of the pre-ML frame into a format suitable for ML graphics processing, such as an input frame tensor.

The ML frame processor 130, which may be implemented as a neural signal processor (NSP), CPU, GPU, or other processing device, is configured to perform a particular ML graphics processing upon the input frame tensor to generate an output frame tensor. As previously discussed, the ML graphics processing may include super-resolution, style transfer, denoising for raytracing, shadow/reflection enhancing, and others. Similarly, the ML-to-GPU frame format converter 140 is configured to convert the output format of the ML processor 130 (e.g., an output frame tensor) into a graphics rendered format (e.g., an array of RGB pixel values), referred to herein as a post-ML frame. The GPU frame display component 110B is configured to receive and buffer the post-ML frame for displaying purposes.

A drawback of the graphics processing system 100 is that the graphics processing is typically slow and has relatively high latency. For example, the GPU frame renderer 110A has to generate a complete pre-ML frame prior to processing the pre-ML frame by the ML processor 130. There is also significant latency with regard to data transfer (e.g., due to relatively low bandwidth (BW)) and format conversion occurring between the GPU frame renderer 110A and the ML processor 130 via the GPU-to-ML format converter 120. Similarly, there is further significant latency with regard to data transfer (e.g., due to relatively low BW and potentially more data, especially in the case of super-resolution) and format conversion occurring between the ML processor 130 and the GPU frame display component 110B via the ML-to-GPU format converter 140. Thus, acceptable real-time graphics processing may not be achieved, especially for BW limited hardware that typically resides in mobile devices, such as smart phones or the like.

FIG. 2 illustrates a block diagram of an example tile-based graphics processing system 200 in accordance with another aspect of the disclosure. As discussed in more detail further herein, the graphics processing system 200 performs graphics processing at the tile-level rather than at the frame-level. A tile is a smaller portion of a frame, which may be two-dimensional in shape, as in a square or rectangular tile. Accordingly, a frame may comprise a set or an array of tiles. By performing graphics processing at the tile-level, the graphics processing system 200 may take advantage of reduced latency due to concurrent processing, and lower bandwidth (BW) data transfers and format conversions.

In particular, the graphics processing system 200 includes a graphics processing unit (GPU) tile renderer 210A, a GPU-to-ML format converter 220, an ML tile processor 230, a ML-to-GPU format converter 240, and a GPU frame generator 210B.

The GPU tile renderer 210A is configured to receive information regarding an input frame, for example, a central processing unit (CPU) running a particular application or under the control of an application layer (e.g., a gaming application, or other). The GPU tile renderer 210A is further configured to sequentially render a set of tiles (referred to herein as “pre-ML tiles”) based on the information regarding the input frame. Similarly, the pre-ML tiles may be in a particular GPU rendered frame format, such as in a red, green blue (RGB) pixel array format. Accordingly, the GPU-to-ML format converter 220 may be configured to sequentially convert the set of pre-ML tiles into a set of input ML tile tensors suitable for ML graphics processing. As discussed further herein, each input ML tile tensor may be based on one or more pre-ML rendered tiles or a fraction of a pre-ML rendered tile (e.g., the size of a pre-ML tile may be different than the size of an ML tile or tensor).

The ML tile processor 230, which may be implemented as a neural signal processor (NSP), CPU, GPU, or other processing device, is configured to sequentially perform a particular ML graphics processing upon the set of input tile tensors to generate a set of output tile tensors, respectively. As previously discussed, the ML graphics processing may include super-resolution, style transfer, denoising for raytracing, shadow/reflection enhancing, and others. Similarly, the ML-to-GPU format converter 240 is configured to sequentially convert the set of output tile tensors outputted by the ML tile processor 230 into a set of post-ML GPU rendered (e.g., RGB) tiles. The GPU frame generator 210B is configured to integrate/assemble the set of post-ML tiles into an output frame for displaying and/or other purposes.

The processing of frames at the tile-level performed by graphics processing system 200 may be significantly faster with lower latency compared to the graphics processing system 100 that processes frames at the frame-level. For instance, the graphics processing system 200 is able to perform concurrent processing. For example, while the ML-to-GPU format converter 240 is converting an output tile tensor into a set of one or more post-ML tiles associated with first-in pre-ML tiles, the ML tile processor 230 may be performing graphics processing of an input tile tensor associated with second-in pre-ML tiles; while the ML tile processor 230 is performing graphics processing of the input tile tensor associated with second-in pre-ML tiles, the GPU-to-ML tile format converter 220 is converting a third-in pre-ML tiles into an input tile tensor; and while the GPU-to-ML tile format converter 220 is converting the third-in pre-ML tiles into the input tile tensor, the GPU tile renderer 210A is rendering a fourth-in pre-ML tiles. Thus, all components 210A, 220, 230, and 240 of the graphics processing system 200 are concurrently processing to ultimately generate an output (ML processed) frame.

Accordingly, this concurrent processing significantly improves the speed at which graphics processing is performed on input frames. Furthermore, as the various components of the graphics pipeline operate on smaller chunks of data (e.g., each tile may be 100×100 pixels²compared to a frame being 4000×1200 pixels²), the bandwidth (BW) required for data transfer, conversion, and ML processing is significantly lower; thereby, speeding up the graphics processing, while reducing the hardware performance requirements (e.g., BW) of each of the components of the pipeline. Thus, the graphics processing system 200 may be implemented in smaller form-factor devices, such as mobile devices, and graphics processing may be performed within an acceptable real-time manner.

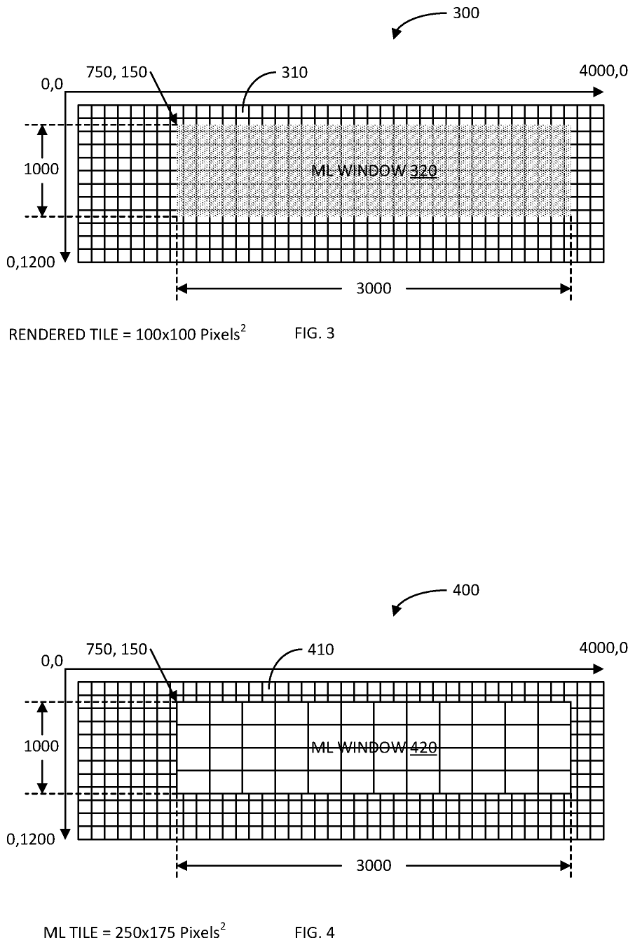

FIG. 3 illustrates a diagram of an example frame 300 in accordance with another aspect of the disclosure. The frame 300 includes a two-dimensional array of pre-ML rendered tiles 310, such as sequentially rendered by the GPU tile renderer 210A previously discussed. In this example, the dimension of the tile array is 40 by 12 tiles; but it shall be understood that the dimension of the tile array may be different. Further, in accordance with this example, each tile 310 may have a size of 100×100 pixels² or other size. Thus, in terms of pixels, the frame 300 may have a resolution of 4000×1200 pixels². In this example, the top-left corner of the frame 300 may have a pixel coordinate of (0,0), the top-right corner of the frame 300 may have a pixel coordinate of (4000,0) and the bottom-left corner of the frame 300 may have a pixel coordinate of (0,1200). The remaining pixels may be identified by such Cartesian coordinates.

In the processing example of graphics processing system 200, it may have been implied that the entire frame including its array of pre-ML tiles undergo the graphics processing of the ML tile processor 230. However, it shall be understood that the ML tile processor 230 may process a first subset or portion of an entire frame 300, while a second subset or portion of the frame 300 may bypass the graphics processing of the ML tile processor 230. In this regard, an ML window 320 (shown as a shaded region) is defined to identify which rendered tiles and/or portions thereof are to be processed by the ML tile processor 230, and which rendered tiles and/or portions thereof are outside of the ML window 320, and are to bypass the ML tile processor 230. For instance, in this example, the top-left corner of the ML window 320, which may be used to specify the position of the ML window 320, may have a pixel coordinate of (750,150), the height of the ML window 320 may be 1000 pixels, and the width of the ML window 320 may be 3000 pixels.

FIG. 4 illustrates a diagram of another example frame 400 in accordance with another aspect of the disclosure. The frame 400 may be similar to frame 300 previously discussed in detail. For example, the frame 400 may include an array of 40×12 tiles 410, where each tile 410 may have a size of 100×100 pixels². Thus, the frame 400 may also have a resolution of 4000×1200 pixels².

In this example, the frame 400 includes an ML window 420 partitioned into an array of ML tiles (compared to ML window 320 partitioned into an array of GPU rendered tiles). As previously discussed, the data chunks (e.g., referred to herein as ML tiles) processed by the ML tile processor 230 may be different than the data chunks (e.g., referred to herein as GPU rendered tiles) processed by the GPU tile renderer 210A. A reason for this is that the size of a GPU rendered tile may be based on the size of the graphics memory (GMEM) of the GPU tile renderer 210A, whereas the size of an ML tile may be based on the memory of the ML tile processor 230. For instance, in this example, each ML tile is 250×175 pixels², whereas each GPU rendered tile, as discussed, is 100×100 pixels².

Accordingly, the size of the ML window 420 in terms of ML tiles is 12×4 ML tiles. It shall be understood that the pixel dimensions of GPU rendered tiles and ML tiles may be based on other factors.

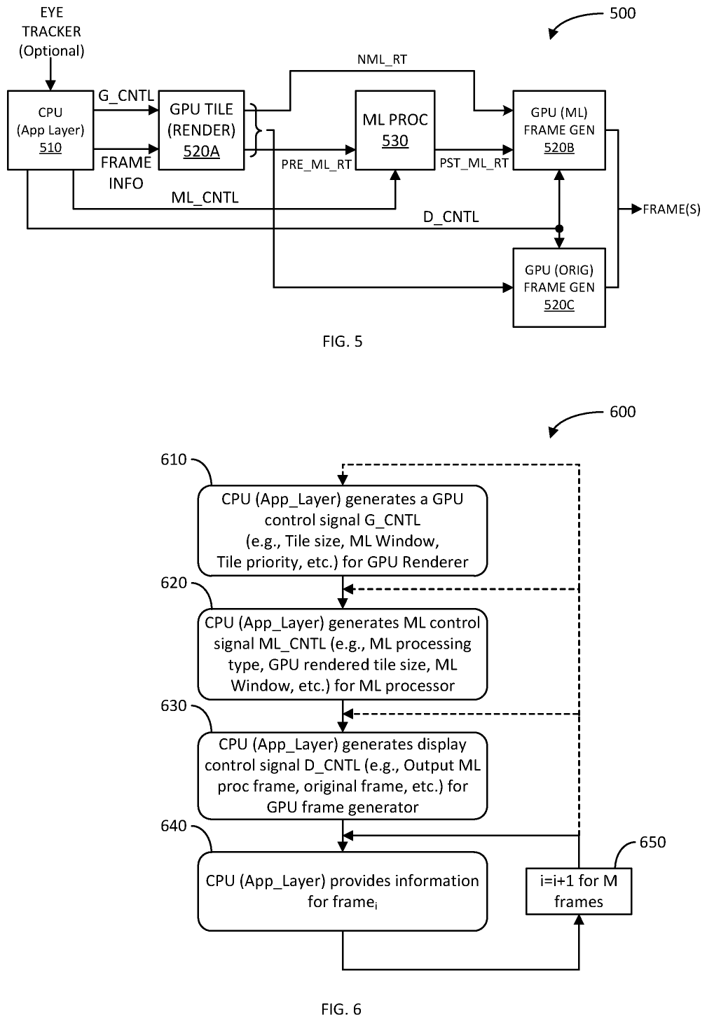

FIG. 5 illustrates a block diagram of another example tile-based graphics processing system 500 in accordance with another aspect of the disclosure. The graphics processing system 500 includes a central processing unit (CPU) 510, a graphics processing unit (GPU) tile renderer, a machine learning (ML) processor, a GPU (ML) frame generator 520B, and GPU (Orig) frame generator 520C.

As discussed in more detail further herein, the CPU 510 may be configured to run an application or in accordance with an application layer to generate information regarding an input frame. In this regard, the CPU 510 may generate a GPU control signal G_CNTL provided to the GPU tile renderer 520A, for example, to set the GPU rendered tile size, define the ML window, set tile rendering priority, and/or other controls. It shall be understood that the ML window may be dynamically defined, for example, based on a position of a user's eyes as detected by an optional eye tracker. In this regard, the graphics processing system 500 may be part of or associated with an X reality (XR) (where X is augmented, virtual, or other) viewer or eyewear. As such, the ML window may be part of a fovea rendering feature of the graphics processing system 500.

The CPU 510 may further generate an ML control signal ML_CNTL provided to the ML processor 530, for example, to specify the type of ML graphics processing to be performed (e.g., super-resolution, style transfer, denoising for raytracing, shadow/reflection enhancing, etc.), the GPU rendered tile size (e.g., 100×100 pixels²), the ML window (e.g., start position, height, and width), and/or other controls. Additionally, the CPU 510 may further generate a display control signal D_CNTL for selecting one or more frames to output for displaying and/or other purposes in accordance with different options (e.g., full screen (one frame), split screen (multiple frames), picture-in-picture (PIP) (multiple frames), etc.). For example, the original rendered frame without ML processing may be simultaneously displayed with the ML processed frame for comparison and/or other purposes.

As discussed in more detail further herein, the GPU tile renderer 520A is configured to sequentially generate a set of GPU rendered tiles that make up the input frame defined by the information received from the CPU 510. The GPU tile renderer 520A may parse the set of GPU rendered tiles into a subset of pre-ML GPU rendered tiles (PRE_ML_RT) to be processed by the ML processor 530, and a subset of non-pre-ML GPU rendered tiles (NML_RT) to bypass the graphics processing of the ML processor 530. It shall be understood that if the defined ML window is null, the subset of pre-ML GPU rendered tiles is also null, and the subset of non-pre-ML GPU rendered tiles encompasses the entire set of GPU rendered tiles. As the pipeline latency associated with the subset of pre-ML GPU rendered tiles is typically greater than the pipeline latency associated with the second subset of non-pre-ML GPU rendered tiles, the GPU tile renderer 520A may prioritize the rendering of the subset of pre-ML GPU rendered tiles (e.g., render the subset of pre-ML GPU rendered tiles before rendering the subset of non-ML GPU rendered tiles).

As discussed in more detail further herein, the ML processor 530 may be configured to receive the first subset of pre-ML GPU rendered tiles, graphics process the first subset of pre-ML GPU rendered tiles to generate a set of post-ML processed GPU rendered tiles based on the ML control signal ML_CNTL received from the CPU 510 and/or other factors. As previously discussed, the ML control signal may specify the type of graphics processing to perform (e.g., super-resolution, style transfer, denoising for raytracing, shadow/reflection enhancing, etc.), the GPU rendered tile size, and the ML window. And, in response to those control parameters, the ML processor 530 may configure the ML processing environment (e.g., number of neural layers, weights, biases, ML tile size, and ML input and output tensor dimensions). The ML processor 530 may then combine one or more of the first subset of pre-ML GPU rendered tiles into an input ML tile, format convert the input ML tile into an input tile tensor, graphics process the input tile tensor to generate an output tile tensor, format convert the output tile tensor into an output ML tile, and parse the output ML tile into a subset of post-ML GPU rendered tiles (PST_ML_RT).

As discussed in more detail further herein, the GPU (ML) frame generator 520B is configured to integrate the subset of non-ML GPU rendered tiles (NML_RT) and the set of post-ML processed rendered tiles (PST_ML_RT) to generate or form an ML processed frame. In a similar manner, the GPU (Orig) frame generator 520C is configured to integrate the subset of non-ML GPU rendered tiles (NML_RT) and the subset of pre-ML GPU rendered tiles (PRE_ML_RT) to generate or form an original frame. The rendered tiles (PRE_ML_RT, NML_RT, and PST-ML_RT) may be in a data structure that defines their positions in a frame for integration/assembly purposes. The GPU (ML and Orig) frame generators 520B and 520C may output the ML processed frame and/or the original frame based on the display control signal D_CNTL received from the CPU 510 (e.g., to full screen display the ML processed frame, to full screen display the original frame, to split screen display the ML processed and original frames, to PIP display the ML processed and original frames, etc.).

FIG. 6 illustrates a flow diagram of an example method 600 of controlling tile rendering, machine learning (ML) graphics processing, and frame displaying in accordance with another aspect of the disclosure. The method 600 may be implemented by the CPU 510 operating under the control of an application or application layer.

The method 600 includes the CPU 510 generating and providing a GPU control signal G_CNTL to the GPU tile renderer 520A (block 610). For example, the GPU control signal G_CNTL may specify the GPU rendered tile size (e.g., 100×100 pixels²), the ML window (e.g., start position=top-left pixel coordinate (750,150), height=1000 pixels, and width=3000 pixels; and may be dynamic based on an eye tracker), and tile rendering priority (e.g., although this may be implicitly set by the defined ML window) (block 610).

The method 600 further includes the CPU 510 generating and providing a machine learning (ML) control signal ML_CNTL to the ML processor 530 (block 620). The ML control signal ML_CNTL may specify the type of ML processing to be performed (e.g., super-resolution, style transfer, denoising for raytracing, shadow/reflection enhancing, etc.), the GPU rendered tile size (e.g., 100×100 pixels²), and the ML window (e.g., start position=pixel (750,150), height=1000 pixels, and width=3000 pixels).

Additionally, the method 600 includes the CPU 510 generating and providing a display control signal D_CNTL to the GPU (ML) frame generator 520B and the GPU (Orig) frame generator 520C (block 630). The display control signal D_CNTL may specify the frames to be outputted by the GPU (ML and Orig) frame generators 520B and 520C for displaying purposes (e.g., full screen display of the ML processed frame, full screen display of the original frame, split screen display of the ML processed and original frames, PIP display of the ML processed and original frames, etc.).

The method 600 further includes the CPU 510 generating and providing information of the i^{th} input frameᵢ to be rendered to the GPU tile renderer 520A (block 640). The operation of block 640 may be repeated for following sequential input frames as indicated by the incrementing of the frame index “i” by one (1) per block 650, and circling back to block 640. This may be the case where the control signals G_CNTL, ML_CNTL, and D_CNTL are static or unchanged. In the case any of the control signals G_CNTL, ML_CNTL, and D_CNTL are dynamically changed, the method 600 may include circling back to any one of the operations indicated in blocks 610, 620, and 630, as indicated by the dashed flow lines.

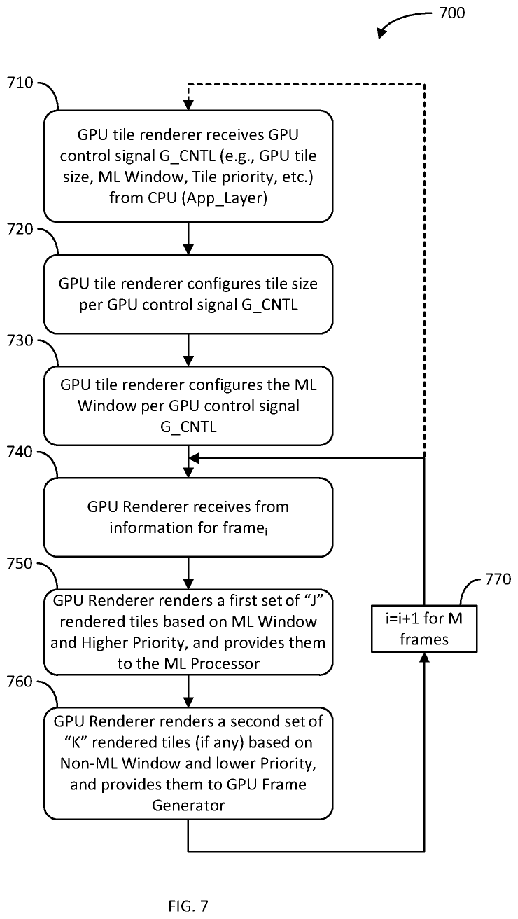

FIG. 7 illustrates a flow diagram of an example method 700 of tile rendering in accordance with another aspect of the disclosure. The method 700 may be implemented by the GPU tile renderer 520A operating under the control of the CPU 510.

The method 700 includes the GPU tile renderer 520A receiving the GPU control signal G_CNTL from the CPU 510 (block 710). As previously discussed, the CPU control signal G_CNTL may specify the GPU rendered tile size (e.g., 100×100 pixels²), the ML window (e.g., start position=pixel (750,150), height=1000 pixels, and width=3000 pixels; and may be dynamic based on an eye tracker), and tile rendering priority (e.g., although this may be implicitly set by the defined ML window).

Then, according to the method 700, the GPU tile renderer 520A may configure the GPU rendered tile size (e.g., 100×100 pixels², which may be a static parameter based on the size of the GPU memory) per the control signal G_CNTL (block 720). Additionally, the method 700 includes the GPU tile renderer 520A configuring the ML window (e.g., start position, height, and width) based on the GPU control signal G_CNTL (block 730).

The method 700 further includes the GPU tile renderer 520A receiving information of the i^{th} input frameᵢ to be rendered from the CPU 510 (block 740). Additionally, the method 700 includes the GPU rendering a first set of “J” GPU rendered tiles based on a higher priority associated with the ML window, and providing the first set of “J” GPU rendered tiles to the ML processor 530 (block 750). Further, the method 700 includes the GPU rendering a second set of “K” GPU rendered tiles based on a lower priority associated with being outside of the ML window, and providing the second set of “K” GPU rendered tiles to the GPU (ML) frame generator 520B (block 750).

The operations of blocks 740, 750, and 760 may be repeated for following sequential input framesᵢ as indicated by the incrementing of the frame index “i” by one (1) per block 770, and circling back to block 740. As previously discussed, this may be the case where the GPU control signal G_CNTL is static or unchanged. In the case where the GPU control signal G_CNTL is dynamic, the method 700 may include circling back to the operations indicated in blocks 710, 720, and 730 to control the rendering process per the changed GPU control signal G_CNTL, as indicated by the dashed flow line.

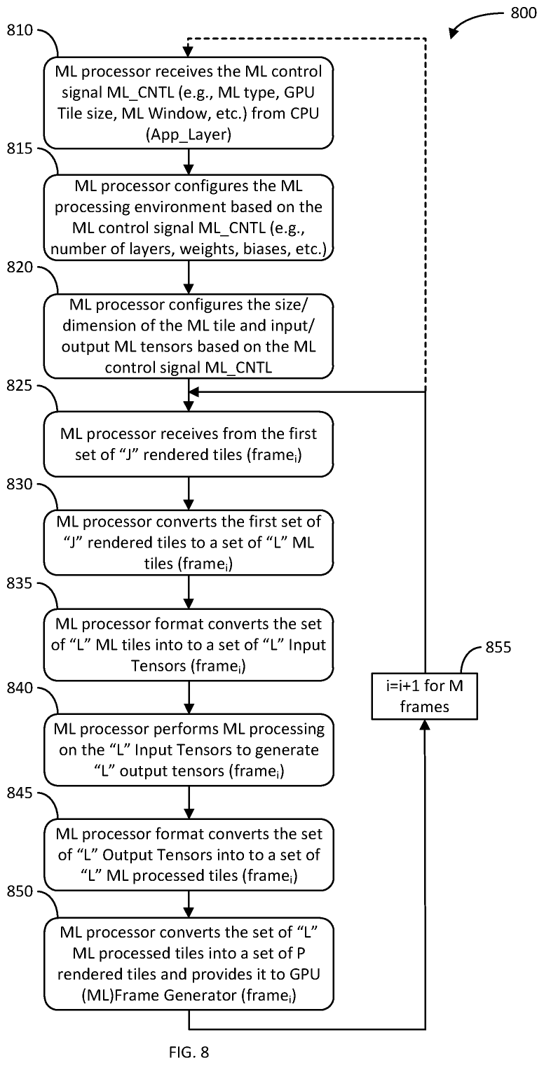

FIG. 8 illustrates a flow diagram of an example method 800 of machine learning (ML) graphics processing in accordance with another aspect of the disclosure. The method 800 may be implemented by the ML processor 530 operating under the control of the CPU 510.

The method 800 includes the ML processor 530 receiving the ML control signal ML_CNTL from the CPU 510 (block 810). As previously discussed, the ML control signal ML_CNTL may specify the type of ML graphics processing to be performed (e.g., (e.g., super-resolution, style transfer, denoising for raytracing, shadow/reflection enhancing, etc.), the GPU rendered tile size (e.g., 100×100 pixels²), and the ML window (e.g., start position=pixel (750,150), height=1000 pixels, and width=3000 pixels). Then, according to the method 800, the ML processor 530 configures the ML processing environment (e.g., number of neural layers, weights, biases, etc.) based on the ML control signal ML_CNTL, and optionally other system resource information (e.g., ML hardware capability, CPU usage, random access memory (RAM) usage, etc.) (block 815). Then method 800 further includes the ML processor 530 configuring the size/dimension of the ML tile and input/output tensors based on the ML control signal (e.g., the type of ML graphics processing) and optionally the system resource information (block 820).

Additionally, the method 800 includes the ML processor 530 receiving a first set of “J” GPU rendered tiles associated with the i^{th} input frame ᵢ (block 825). Further, according to the method 800, the ML processor 530 converts the first set of “J” rendered tiles into a set of “L” ML tiles associated with i^{th} input frameᵢ (block 830). Then, the method 800 includes the ML processor 530 converting the set of “L” ML tiles into a set of “L” input tensors associated with i^{th} input frameᵢ (block 835). Also, the method 800 includes the ML processor 840 processing the set of “L” input tensors to generate a set of “L” output tensors associated with the i^{th} input frameᵢ (block 840). The method 800 additionally includes the ML processor 530 converting the set of “L” output tensors into a set of “L” ML processed tiles associated with the i^{th} input frameᵢ (block 845). Then, the ML processor 530, according to the method 800, converts the set of “L” ML processed tiles into a set of “P” ML rendered tiles associated with the i^{th} input frameᵢ, and provides them to the GPU (ML) frame generator 520B (block 850).

The operations of blocks 825 to 850 may be repeated for following sequential input framesᵢ as indicated by the incrementing of the frame index “i” by one (1) per block 855, and circling back to block 825. As previously discussed, this may be the case where the ML control signal ML_CNTL is static or unchanged. In the case where the ML control signal ML_CNTL is dynamic, the method 800 may include circling back to block 810 followed by blocks 815 and 820 to reconfigure the ML processing environment per the changed ML control signal ML_CNTL, as indicated by the dashed flow line.

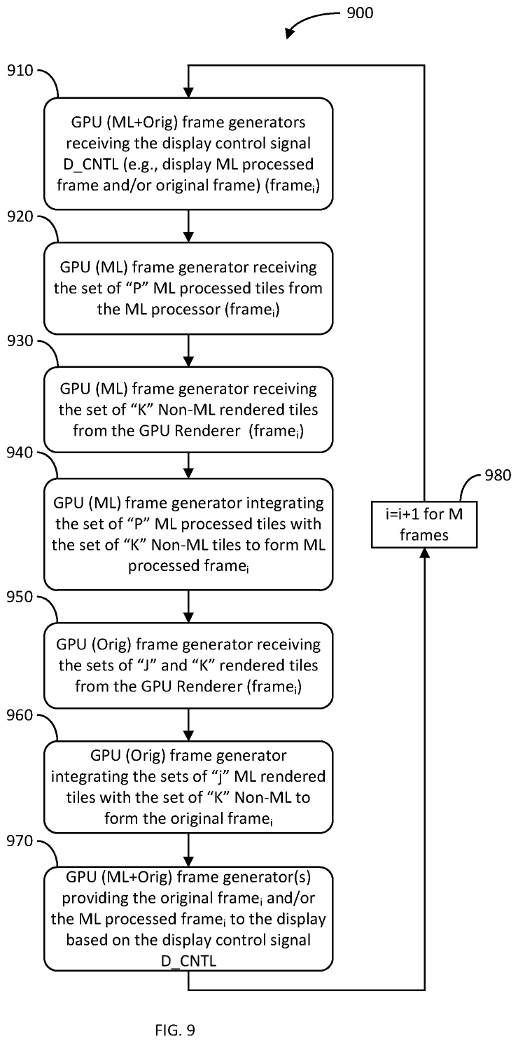

FIG. 9 illustrates a flow diagram of an example method of displaying frames in accordance with another aspect of the disclosure. The method 900 may be implemented by the GPU (ML and Orig) frame generators 520B and 520C operating under the control of the CPU 510.

The method 900 includes the GPU (ML and Orig) frame generators 520B and 520C receiving the display control signal D_CNTL from the CPU 510 associated with the i^{th} input frameᵢ (block 910). As previously discussed, the ML control signal ML_CNTL may specify which of the ML processed frame and/or original frame to display, and the manner in which they are to be displayed (e.g., full screen display of the ML processed frame, full screen display of the original frame, split screen display of the ML processed and original frames, PIP display of the ML processed and original frames, etc.).

The method 900 further includes the GPU (ML) frame generator 520B receiving the set of “P” ML processed tiles from the ML processor 530 associated with the i ^{th} input frameᵢ (block 920). Additionally, the method 900 includes the GPU (ML) frame generator 520B receiving the set of “K” non-ML rendered tiles from the GPU renderer 520A associated with the i^{th} input frameᵢ (block 930). Further, the method 900 includes the GPU (ML) frame generator 520B integrating the set of “P” ML processed tiles with the set of “K” non-ML tiles to form the i^{th} ML processed frameᵢ (block 940).

Additionally, the method 900 includes the GPU (Orig) frame generator 520C receiving the sets of “J” and “K” rendered tiles from the GPU renderer 520A associated with the i^{th} input frameᵢ (block 950). The method 900 includes the GPU (Orig) frame generator 520C integrating the sets of “”J″ and “K” rendered tiles to form the i^{th} original frameᵢ (block 960). Then, according to the method 900, the GPU (ML and Orig) frame generator(s) 520B and 520C providing the i^{th} ML processed frameᵢand/or the i^{th} original frameᵢ to the display based on the display control signal D_CNTL (block 970). The operations of blocks 910 to 970 may be repeated for following sequential input framesᵢ as indicated by the incrementing of the frame index “i” by one (1) per block 980, and circling back to block 910.

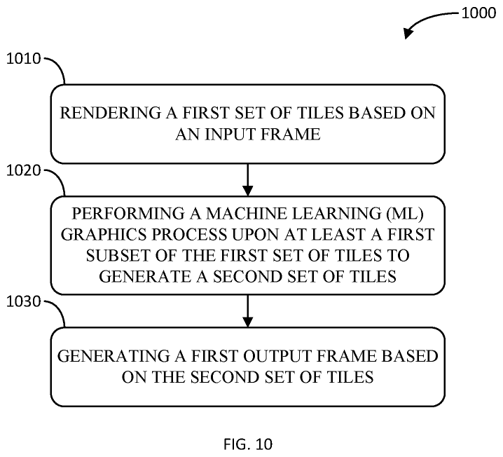

FIG. 10 illustrates a flow diagram of an example method 1000 of generating an output frame in accordance with another aspect of the disclosure. The method 1000 includes rendering a first set of tiles based on an input frame (block 1010). Examples of means for rendering a first set of tiles based on an input frame include any of the GPU tile renderers described herein. The method 1000 further includes performing a machine learning (ML) graphics process upon at least a first subset of the first set of tiles to generate a second set of tiles (block 1020). Examples of means for performing a machine learning (ML) graphics process upon at least a first subset of the first set of tiles to generate a second set of tiles include any of the ML processors described herein. Additionally, the method 1000 includes generating a first output frame based on the second set of tiles (block 1030). Examples of means for generating a first output frame based on the second set of tiles include any of the frame generators described herein.

Some of the components described herein, such as one or more of the subsystems, thermal controllers, and communication interfaces, may be implemented using a processor. A processor, as used herein, may be any dedicated circuit, processor-based hardware, a processing core of a system on chip (SOC), etc. Hardware examples of a processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor may be coupled to memory (e.g., generally a computer-readable media or medium), such as a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

The following provides an overview of aspects of the present disclosure:

Aspect 1: A graphics processing system, comprising: a graphics processing unit (GPU) renderer configured to render a first set of tiles based on an input frame; a machine learning (ML) graphics processor configured to perform a graphics process based upon at least a first subset of the first set of tiles to generate a second set of tiles; and a first frame generator configured to generate a first output frame based on the second set of tiles.

Aspect 2: The graphics processing system of aspect 1, wherein the first set of tiles comprises a second subset of tiles, wherein the first frame generator is configured to integrate the second subset of tiles with the second set of tiles to generate the first output frame.

Aspect 3: The graphics processing system of aspect 2, wherein the GPU renderer is configured to render the first subset of the first set of tiles prior to rendering the second subset of tiles.

Aspect 4: The graphics processing system of aspect 2 or 3, further comprising a central processing unit (CPU) configured to generate and provide a control signal to the GPU renderer that defines a machine learning (ML) window including the second subset of tiles.

Aspect 5: The graphics processing system of aspect 4, wherein the control signal specifies a position within the input frame, a height, and a width of the ML window.

Aspect 6: The graphics processing system of any one of aspects 1-5, further comprising a first format converter configured to generate a first set of machine learning (ML) tiles based on at least the first subset of tiles, wherein the ML graphics processor is configured to perform the graphics process based upon the first set of ML tiles to generate the second set of tiles.

Aspect 7: The graphics processing system of aspect 6, wherein a size of each of the first set of ML tiles is different than a size of each of the first subset of tiles.

Aspect 8: The graphics processing system of aspect 6 or 7, wherein a size of each of the first set of ML tiles is greater than a size of each of the first subset of tiles.

Aspect 9: The graphics processing system of any one of aspects 6-8, further comprising a central processing unit (CPU) configured to generate and provide a control signal to the ML graphics processor to specify a type of the graphics process performed upon the first subset of the first set of tiles.

Aspect 10: The graphics processing system of aspect 9, wherein the ML graphics process is configured to size each of the first set of ML tiles based on the graphics process type.

Aspect 11: The graphics processing system of aspect 9 or 10, wherein the ML graphics process is configured to size each of the first set of ML tiles based on system resource information.

Aspect 12: The graphics processing system of any one of aspects 6-11, wherein the first format converter is configured to convert the first set of ML tiles into a set of input tensors, wherein the ML graphics processor is configured to perform the graphics process upon the set of input tensors to generate a set of output tensors, wherein the second set of tiles is based on the set of output tensors.

Aspect 13: The graphics processing system of aspect 12, further comprising a second format converter configured to convert the set of output tensors into a second set of ML tiles, wherein the second set of tiles is based on the second set of ML tiles.

Aspect 14: The graphics processing system of aspect 13, wherein the second format converter is configured to convert the second set of ML tiles into the second set of tiles.

Aspect 15: The graphics processor system of any one of aspects 1-14, wherein the graphics process comprises a super-resolution process.

Aspect 16: The graphics processor system of any one of aspects 1-15, wherein the graphics process comprises a style transfer process.

Aspect 17: The graphics processor system of any one of aspects 1-16, wherein the graphics process comprises a denoising for raytracing process.

Aspect 18: The graphics processing system of any one of aspects 1-17, wherein the first set of tiles comprises a second subset of tiles, and further comprising a second frame generator configured to integrate the first and second subset of tiles to generate a second output frame.

Aspect 19: The graphics processing system of aspect 18, further comprising a central processing unit (CPU) configured to generate and provide a control signal to the first and second frame generators to control a displaying of at least one of the first or second output frame.

Aspect 20: The graphics processing system of aspect 19, wherein the third frame includes a full screen of the first output frame, a full screen of the second output frame, a split screen including the first and second output frames, or a picture-in-picture (PIP) including the first and second output frames.

Aspect 21: A method, comprising: rendering a first set of tiles based on an input frame; performing a machine learning (ML) graphics process upon at least a first subset of the first set of tiles to generate a second set of tiles; and generating a first output frame based on the second set of tiles.

Aspect 22: The method of aspect 21, wherein: the first set of tiles comprises a second subset of tiles; and generating the first output frame comprises integrating the second subset of tiles with the second set of tiles.

Aspect 23: The method of aspect 22, further comprising specifying a machine learning (ML) window including the first subset of tiles of the input frame to undergo the ML graphics processing, wherein the second subset of tiles are outside of the ML window so as to bypass the ML graphics processing.

Aspect 24: The method of aspect 22 or 23, further comprising generating a second frame comprising the first and second subsets of tiles.

Aspect 25: The method of any one of aspects 21-24, further comprising converting the first subset of tiles into a first set of machine learning (ML) tiles, wherein a size of each of the first set of ML tiles is different than a size of each of the first subset of tiles, and wherein the second set of tiles is based on the set of machine learning (ML) tiles.

Aspect 26: The method of aspect 25, further comprising setting the size of each of the first set of ML tiles based on a type of the ML graphics process.

Aspect 27: The method of aspect 25 or 26, further comprising setting the size of each of the first set of ML tiles based on system resource information.

Aspect 28: The method of any one of aspects 25-27, further comprising: converting the first set of ML tiles into a first set of tensors, wherein performing the ML graphics process comprises performing the ML graphics process upon the first set of tensors to generate a second set of tensors; converting the second set of tensors into a second set of ML tiles; and converting the second set of ML tiles into the second set of tiles.

Aspect 29: The method of any one of aspects 21-28, wherein the ML graphics process comprises at least one of a super-resolution process, a style transfer process, or a denoising for raytracing process.

Aspect 30: An apparatus, comprising: means for rendering a first set of tiles based on an input frame; means for performing a machine learning (ML) graphics process upon at least a first subset of the first set of tiles to generate a second set of tiles; and means for generating an output frame based on the second set of tiles.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. A graphics processing system, comprising:
a graphics processing unit (GPU) renderer configured to render a first set of tiles based on an input frame;
a machine learning (ML) graphics processor configured to perform a graphics process based upon at least a first subset of the first set of tiles to generate a second set of tiles; and
a first frame generator configured to generate a first output frame based on the second set of tiles.

2. The graphics processing system of claim 1, wherein the first set of tiles comprises a second subset of tiles, wherein the first frame generator is configured to integrate the second subset of tiles with the second set of tiles to generate the first output frame.

3. The graphics processing system of claim 2, wherein the GPU renderer is configured to render the first subset of the first set of tiles prior to rendering the second subset of tiles.

4. The graphics processing system of claim 2, further comprising a central processing unit (CPU) configured to generate and provide a control signal to the GPU renderer that defines a machine learning (ML) window including the second subset of tiles.

5. The graphics processing system of claim 4, wherein the control signal specifies a position within the input frame, a height, and a width of the ML window.

6. The graphics processing system of claim 1, further comprising a first format converter configured to generate a first set of machine learning (ML) tiles based on the first subset of tiles, wherein the ML graphics processor is configured to perform the graphics process based upon the first set of ML tiles to generate the second set of tiles.

7. The graphics processing system of claim 6, wherein a size of each of the first set of ML tiles is different than a size of each of the first subset of tiles.

8. The graphics processing system of claim 6, wherein a size of each of the first set of ML tiles is greater than a size of each of the first subset of tiles.

9. The graphics processing system of claim 6, further comprising a central processing unit (CPU) configured to generate and provide a control signal to the ML graphics processor to specify a type of the graphics process performed upon the first subset of the first set of tiles.

10. The graphics processing system of claim 9, wherein the ML graphics process is configured to size each of the first set of ML tiles based on the graphics process type.

11. The graphics processing system of claim 9, wherein the ML graphics process is configured to size each of the first set of ML tiles based on system resource information.

12. The graphics processing system of claim 6, wherein the first format converter is configured to convert the first set of ML tiles into a set of input tensors, wherein the ML graphics processor is configured to perform the graphics process upon the set of input tensors to generate a set of output tensors, wherein the second set of tiles is based on the set of output tensors.

13. The graphics processing system of claim 12, further comprising a second format converter configured to convert the set of output tensors into a second set of ML tiles, wherein the second set of tiles is based on the second set of ML tiles.

14. The graphics processing system of claim 13, wherein the second format converter is configured to convert the second set of ML tiles into the second set of tiles.

15. The graphics processor system of claim 1, wherein the graphics process comprises a super-resolution process.

16. The graphics processor system of claim 1, wherein the graphics process comprises a style transfer process.

17. The graphics processor system of claim 1, wherein the graphics process comprises a denoising for raytracing process.

18. The graphics processing system of claim 1, wherein the first set of tiles comprises a second subset of tiles, and further comprising a second frame generator configured to integrate the first and second subset of tiles to generate a second output frame.

19. The graphics processing system of claim 18, further comprising a central processing unit (CPU) configured to generate and provide a control signal to the first and second frame generators to control a displaying of a third frame including at least one of the first or second output frame.

20. The graphics processing system of claim 19, wherein the third frame includes a full screen of the first output frame, a full screen of the second output frame, a split screen including the first and second output frames, or a picture-in-picture (PIP) including the first and second output frames.

21. A method, comprising:
rendering a first set of tiles based on an input frame;
performing a machine learning (ML) graphics process upon at least a first subset of the first set of tiles to generate a second set of tiles; and
generating a first output frame based on the second set of tiles.

22. The method of claim 21, wherein:
the first set of tiles comprises a second subset of tiles; and
generating the first output frame comprises integrating the second subset of tiles with the second set of tiles.

23. The method of claim 22, further comprising specifying a machine learning (ML) window including the first subset of tiles of the input frame to undergo the ML graphics processing, wherein the second subset of tiles are outside of the ML window so as to bypass the ML graphics processing.

24. The method of claim 22, further comprising generating a second frame comprising the first and second subsets of tiles.

25. The method of claim 21, further comprising converting the first subset of tiles into a first set of machine learning (ML) tiles, wherein a size of each of the first set of ML tiles is different than a size of each of the first subset of tiles, and wherein the second set of tiles is based on the set of machine learning (ML) tiles.

26. The method of claim 25, further comprising setting the size of each of the first set of ML tiles based on a type of the ML graphics process.

27. The method of claim 25, further comprising setting the size of each of the first set of ML tiles based on system resource information.

28. The method of claim 25, further comprising:
converting the first set of ML tiles into a first set of tensors, wherein performing the ML graphics process comprises performing the ML graphics process upon the first set of tensors to generate a second set of tensors;
converting the second set of tensors into a second set of ML tiles; and
converting the second set of ML tiles into the second set of tiles.

29. The method of claim 21, wherein the ML graphics process comprises at least one of a super-resolution process, a style transfer process, or a denoising for raytracing process.

30. An apparatus, comprising:
means for rendering a first set of tiles based on an input frame;
means for performing a machine learning (ML) graphics process upon at least a first subset of the first set of tiles to generate a second set of tiles; and
means for generating an output frame based on the second set of tiles.
